(19) United States
(12) Patent Application Publication
(10) Pub. No.: US 2026/0241273 A1
(43) Pub. Date: Aug. 20, 2026

(54) PRIZE ACQUISITION GAME DEVICE

(71) Applicant: SEGA CORPORATION, Tokyo (JP)

(72) Inventors: Yuuki Hanafusa, Tokyo (JP); Keigo Inuyama, Tokyo (JP); Asako Tominaga, Tokyo (JP)

(73) Assignee: SEGA CORPORATION, Tokyo (JP)

(21) Appl. No.: 19/574,050

(22) Filed: Mar. 20, 2026

Related U.S. Application Data
(63) Continuation of application No. PCT/JP2024/018282, filed on May 17, 2024.

(30) Foreign Application Priority Data
Sep. 29, 2023 (JP) 2023-170956

(51) Int. Cl. A63F 9/30; G07F 17/32

(52) U.S. Cl. CPC A63F 9/30; G07F 17/3216; G07F 17/3297; A63F 2250/142

(57) ABSTRACT

A prize acquisition game device includes: a casing that houses a prize; an opening/closing door disposed on a front surface of the casing; an operation console disposed protruding forward of the casing; a prize catcher that comprises an arm and acquires the prize based on a game operation performed on the operation console; and a locking mechanism that locks or unlocks the opening/closing door with rotation of a key inserted into a keyhole, a mounting surface of the keyhole being disposed on a side surface of the operation console to be oriented obliquely forward.

### BACKGROUND

### TECHNICAL FIELD

The present invention relates to a prize acquisition game device.

### DESCRIPTION OF RELATED ART

A prize acquisition game device is known, which is provided with a casing that houses a prize; an opening/closing door provided on a front surface of the casing; and a locking mechanism for bringing the opening/closing door into a locked state or an unlocked state by rotation of a key inserted into a keyhole (for example, Patent Document 1).

### Patent Documents

Patent Document 1: JP 2020-010855 A

Technological Problem to Be Solved by Invention

In the prize acquisition game device taught in Patent Document 1, the keyhole into which the key is inserted is disposed on the front surface of the casing. Disposing in this manner provides high visibility when an operator (store staff or the like) brings the opening/closing door into an unlocked state to replenish prizes in the casing, making it easier to put in and take out the key from the keyhole; however, there is a risk that the design appearance of the prize acquisition game device may be impaired when viewed from the front.

### SUMMARY

One or more embodiments of the present invention provide a prize acquisition game device that comprises a keyhole disposed to improve visibility without impairing design appearance.

According to one aspect of the present invention, a prize acquisition game device comprises a casing that houses a prize; an opening/closing door disposed on a front surface of the casing; an operation console disposed protruding forward of the casing; a prize catcher that comprises an arm and acquires the prize based on a game operation performed on the operation console; and a locking mechanism that locks or unlocks the opening/closing door with rotation of a key inserted into a keyhole, wherein a mounting surface of the keyhole is disposed on a side surface of the operation console to be oriented obliquely forward.

Other features of the present invention will become apparent from the description of the present specification and the accompanying drawings.

### BRIEF DESCRIPTION OF DRAWINGS

FIG. 1 is an external view illustrating a configuration of a prize acquisition game device 1 according to one or more embodiments.

FIG. 2 is a schematic view illustrating a configuration of a moving unit 50 according to one or more embodiments.

FIG. 3A is a perspective view illustrating a left end of an operation console 70 before a first operation unit 71a on a left side is removed.

FIG. 3B is a perspective view illustrating the left end of the operation console 70 after the first operation unit 71a on the left side is removed.

FIG. 4A is a plan view illustrating the left end of the operation console 70 before a first operation unit 71a on the left side is removed.

FIG. 4B is a plan view illustrating the left end of the operation console 70 after the first operation unit 71a on the left side is removed.

FIG. 5A is a schematic perspective view illustrating a first locking mechanism 80a when a left door 11a is brought into a locked state.

FIG. 5B is a schematic cross-sectional view illustrating the first locking mechanism 80a when the left door 11a is brought into a locked state.

FIG. 6A is a schematic perspective view illustrating the first locking mechanism 80a when the left door 11a is brought into an unlocked state.

FIG. 6B is a schematic cross-sectional view illustrating the first locking mechanism 80a when the left door 11a is brought into an unlocked state.

### DETAILED DESCRIPTION OF EMBODIMENTS

At least the following will become apparent from the description of the present specification and the accompanying drawings.

Specifically, a prize acquisition game device comprises a casing that houses a prize; an opening/closing door disposed on a front surface of the casing; an operation console disposed protruding forward of the casing; a prize catcher that comprises an arm and acquires the prize based on a game operation performed on the operation console; and a locking mechanism that locks or unlocks the opening/closing door with rotation of a key inserted into a keyhole, wherein a mounting surface of the keyhole is disposed on a side surface of the operation console to be oriented obliquely forward.

According to this prize acquisition game device, the keyhole into which the key is inserted is mounted to the side surface of the operation console, and thus the design appearance of the prize acquisition game device are not impaired even when being viewed from the front; in addition, since the mounting surface of the keyhole is disposed on the side surface of the operation console, in a state of being oriented obliquely forward, visibility is also improved, making it easier to insert the key into the keyhole and take out the key from the keyhole.

In addition, in such a prize acquisition game device, the opening/closing door may include a left door and a right door, the locking mechanism may include a first locking mechanism for the left door and a second locking mechanism for the right door, and the mounting surface includes: a left mounting surface disposed on a left side surface of the operation console to be oriented obliquely forward, and a right mounting surface disposed on a right side surface of the operation console to be oriented obliquely forward.

According to this prize acquisition game device, even in a case where a locking mechanism is provided to correspond to the left door and the right door, respectively, a keyhole into which a key is inserted is mounted to each of the left and right side surfaces of the operation console, and thus the design appearance of the prize acquisition game device are not impaired even when viewed from the front; in addition, since the mounting surface of each keyhole is disposed on the left and right side surfaces, respectively, of the operation console and in a state of being oriented obliquely forward, visibility is also improved, making it easier to insert the key into the keyhole and take out the key from the keyhole.

Furthermore, in such a prize acquisition game device, the operation console has a length in a left-right direction shorter than a length of the casing in a left-right direction to form a key operation space on both a left and right side of the operation console.

According to this prize acquisition game device, even if the prize acquisition game device is installed with a side surface of the casing close to a wall or the prize acquisition game device is installed next to another game device, the key operation space is ensured on both the left and right sides of the operation console, making it easier to insert the key into the keyhole and take out the key from the keyhole.

### Embodiments

### Configuration of prize acquisition game device

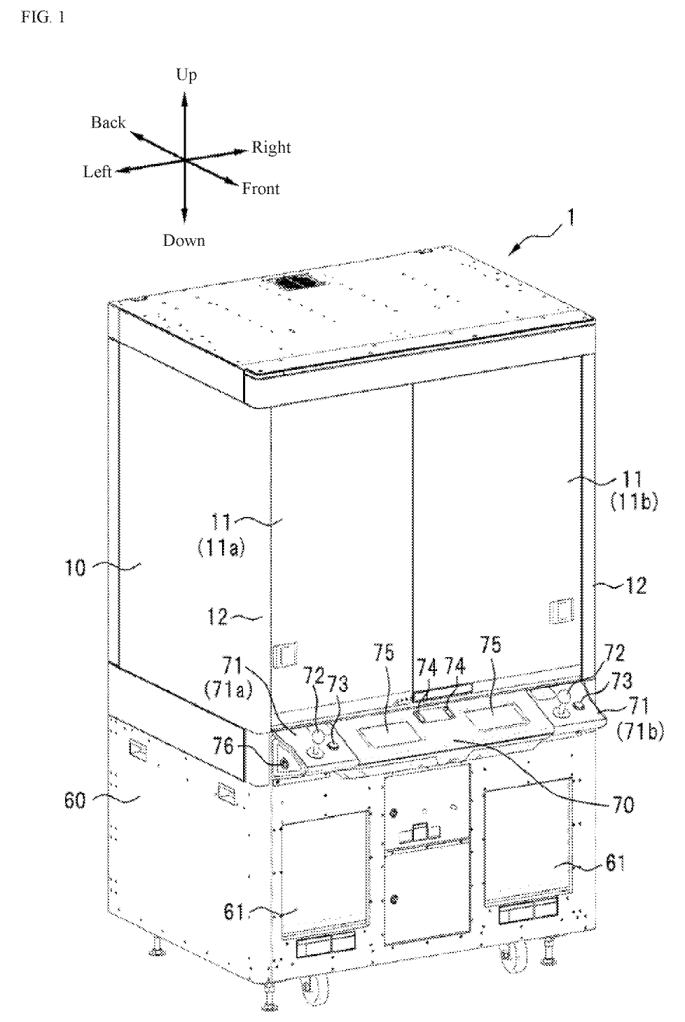

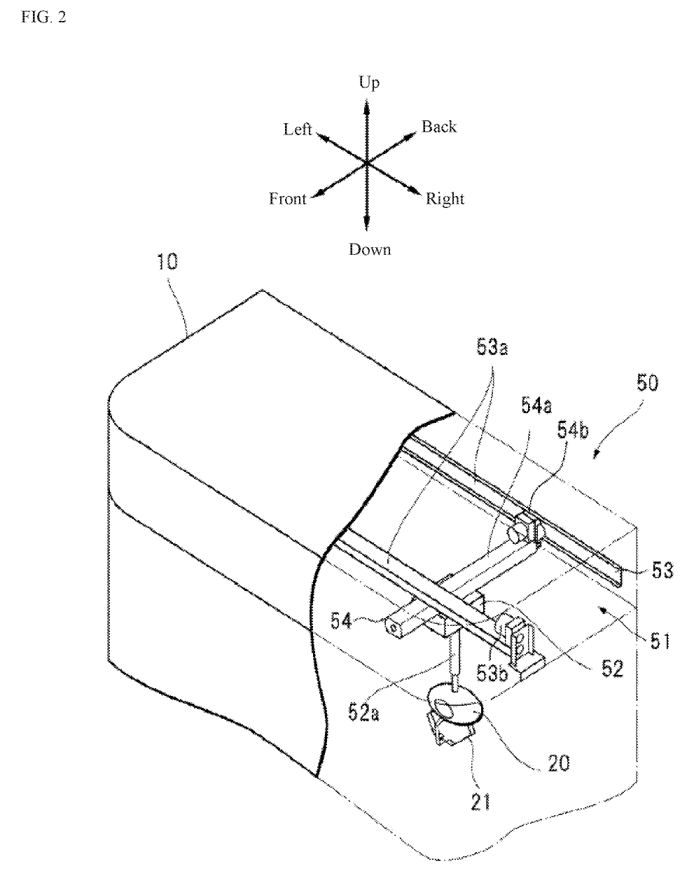

A configuration example of a prize acquisition game device 1 according to one or more embodiments will be described with reference to FIGS. 1 and 2. The prize acquisition game device 1 of one or more embodiments comprises a CPU (Central Processing Unit), a ROM (Read Only Memory), and a RAM (Random Access Memory) to control components of the prize acquisition game device 1 such as various sensors and motors. FIG. 1 is an external view illustrating a configuration of the prize acquisition game device 1 according to one or more embodiments. FIG. 2 is a schematic view illustrating a configuration of a moving unit 50 according to one or more embodiments.

In the following description, each direction is defined as illustrated in each drawing. That is, the vertical direction is defined as the "up-down direction", and "up" and "down" are defined according to gravity. In addition, the "front-back direction" is defined as the "front" being the front side and the "back" being the back side from the perspective of a player playing a game, facing the prize acquisition game device 1. Additionally, the direction perpendicular to the up-down direction and the front-back direction is defined as the "left-right direction", and "right" and "left" are defined based on when viewed from the player.

The prize acquisition game device 1 according to one or more embodiments is used when a player plays a prize acquisition game, and is provided with a casing 10 that stores one or more prizes, and a base unit 60 disposed below the casing 10.

As illustrated in FIG. 1, the casing 10 is formed of transparent members (for example, transparent resin, glass, or the like) on a front surface and left and right side surfaces so that the prizes housed within a housing space may be seen by the player. An opening/closing door (or slide door) 11 formed of a transparent member is disposed on the front surface of the casing 10, which allows an operator (for example, store staff) to perform operations such as displaying and replenishing of prizes, or the like. Pillar portions 12 are disposed at the four corners of the casing 10.

The opening/closing door 11 is a sliding door that opens and closes by sliding along a rail that extends in the left-right direction. As illustrated in FIG. 1, by turning a key inserted into a keyhole 76 disposed on a side surface of an operation console 70, the opening/closing door 11 may be brought into a locked state or an unlocked state by an action of a locking mechanism disposed on the base unit 60.

As illustrated in FIG. 1, the opening/closing door 11 in one or more embodiments has a left door 11a and a right door 11b, and may be opened and closed from both the left and right sides. In one or more embodiments, locking mechanisms (a first locking mechanism and a second locking mechanism) are disposed to correspond to the left door 11a and the right door 11b, respectively.

Therefore, when opening the left door 11a, the key inserted into the keyhole 76 on the left side is turned to operate the first locking mechanism for the left door, thereby bringing the left door 11a from a locked state to an unlocked state, and then the left door 11a is slid to the right side.

In addition, when opening the right door 11b, the key inserted into the keyhole 76 on the right side (not illustrated) is turned to operate the second locking mechanism for the right door, thereby bringing the right door 11b from a locked state to an unlocked state, and then the right door 11b is slid to the left side.

The housing space enclosed by the casing 10 is used as a play area for a player to play the prize acquisition game. When the pillar portions 12 on both sides of the opening/closing door 11 are formed of a mirror-like member or a transparent member, they will not stand out visually, which may make the play area look wider.

As illustrated in FIG. 2, the casing 10 in one or more embodiments has a prize acquisition unit (or prize catcher) 20 that performs and action to acquire a prize in the housing space, and the moving unit 50 that moves the prize acquisition unit 20 in the housing space.

In one or more embodiments, a first play area is formed on the left side within the housing space, and a second play area is formed on the right side within the housing space, which is where the player plays the prize acquisition game. The prize acquisition unit 20 is disposed to correspond to the first play area on the left side and the second play area on the right side, respectively. Therefore, within each play area, each prize acquisition unit 20 is configured to move and be able to acquire a prize.

The prize acquisition unit 20 is for acquiring a prize housed in the casing 10 by operating an arm to open and close. As illustrated in FIG. 2, the prize acquisition unit 20 in one or more embodiments is configured so as to be able to grasp a prize by three arms 21, and is linked to a lower end of a lifting member 52a.

As illustrated in FIG. 2, the moving unit 50 is disposed at an upper portion within the casing 10, and moves the prize acquisition unit 20 within the play area formed by the casing 10. As illustrated in FIG. 2, the moving unit 50 in one or more embodiments includes a horizontal moving unit 51 and a vertical moving unit 52.

The horizontal moving unit 51 moves the prize acquisition unit 20 in a horizontal direction (that is, in the front-back direction and the left-right direction) in the play area. As illustrated in FIG. 2, the horizontal moving unit 51 in one or more embodiments includes a left-right moving unit 53 and a front-back moving unit 54.

The left-right moving unit 53 moves the prize acquisition unit 20 in the left-right direction in the play area.

As illustrated in FIG. 2, the left-right moving unit 53 in one or more embodiments comprises a pair of fixed rails 53a extending along the left-right direction, a left-right movement motor 53b, an encoder (not illustrated), and a limit sensor (not illustrated).

A pair of fixed rails 53a is fixed to the upper portion of the casing 10 so as to be mutually parallel along the left-right direction. The front-back moving unit 54 is mounted to the pair of fixed rails 53a so as to be slidable along the left-right direction. The front-back moving unit 54 may be moved in the left-right direction along the fixed rails 53a by driving the left-right movement motor 53b.

The encoder detects the number of rotations of the left-right movement motor 53b. The position of the front-back moving unit 54 in the left-right direction (in other words, the position of the prize acquisition unit 20 in the left-right direction) may be detected based on the output of this encoder.

The limit sensor is for detecting that the front-back moving unit 54 has reached a limit position in the left-right direction (that is, that the prize acquisition unit 20 has reached a limit position in the left-right direction).

The front-back moving unit 54 moves the prize acquisition unit 20 in the front-back direction in the play area.

As illustrated in FIG. 2, the front-back moving unit 54 in one or more embodiments comprises a movable rail 54a extending along the front-back direction, a front-back movement motor 54b, an encoder (not illustrated), and a limit sensor (not illustrated).

The vertical moving unit 52 is mounted to the movable rail 54a so as to be slidable along the front-back direction. The vertical moving unit 52 may be moved in the front-back direction along the movable rail 54a by driving the front-back movement motor 54b.

The encoder detects the number of rotations of the front-back movement motor 54b. The position of the vertical moving unit 52 in the front-back direction (that is, the position of the prize acquisition unit 20 in the front-back direction) may be detected based on the output of this encoder.

The limit sensor is for detecting that the vertical moving unit 52 has reached a limit position in the front-back direction (that is, that the prize acquisition unit 20 has reached a limit position in the front-back direction).

The vertical moving unit 52 moves the prize acquisition unit 20 in the vertical direction (that is, the up-down direction) in the play area.

As illustrated in FIG. 2, the vertical moving unit 52 in one or more embodiments has a lifting member (or lifter) 52a that is configured to be expandable and contractable along the up-down direction, a wire winding unit (or wire winder) (not illustrated), an up-down movement motor (not illustrated), an upper limit sensor (not illustrated), and a lower limit sensor (not illustrated).

The lifting member 52a is constituted by slidably fitting a plurality of pipes of successively smaller diameters in a telescopic manner. The prize acquisition unit 20 is mounted to a lower end portion of the lifting member 52a in a state of being connected to a wire that passes through an inner side of a pipe.

By driving the up-down movement motor, the wire winding unit raises the prize acquisition unit 20 by winding up the wire, thereby sequentially storing lower pipes into upper pipes, or lowers the prize acquisition unit 20 by rewinding the wire, thereby sequentially sending the lower pipes from the upper pipes.

The upper limit sensor detects whether the raising of the prize acquisition unit 20 has stopped by winding up the wire connected to the prize acquisition unit 20.

The lower limit sensor detects whether the lowering of the prize acquisition unit 20 has stopped based on a change in the tension of the wire connected to the prize acquisition unit 20.

The base unit 60 is a base portion of a cabinet disposed below the casing 10, and holds the casing 10 at a high position so that the player is able to play the game while facing the front in a standing position.

As illustrated in FIG. 1, the base unit 60 in one or more embodiments has a prize retrieval outlet 61 for retrieving a prize that has fallen from the play area after being acquired by the prize acquisition unit 20, the operation console 70 disposed protruding forward of the casing 10, and a locking mechanism 80 (not illustrated) that brings the opening/closing door 11 into a locked state or unlocked state. Specific configurations of the operation console 70 and the locking mechanism 80 will be described below.

### Configuration of operation console 70

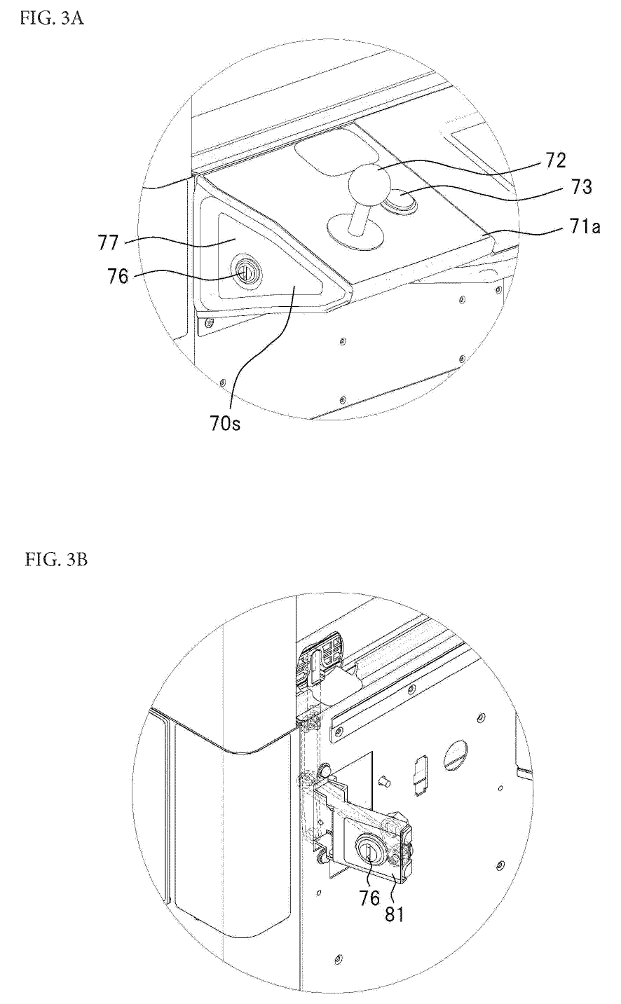

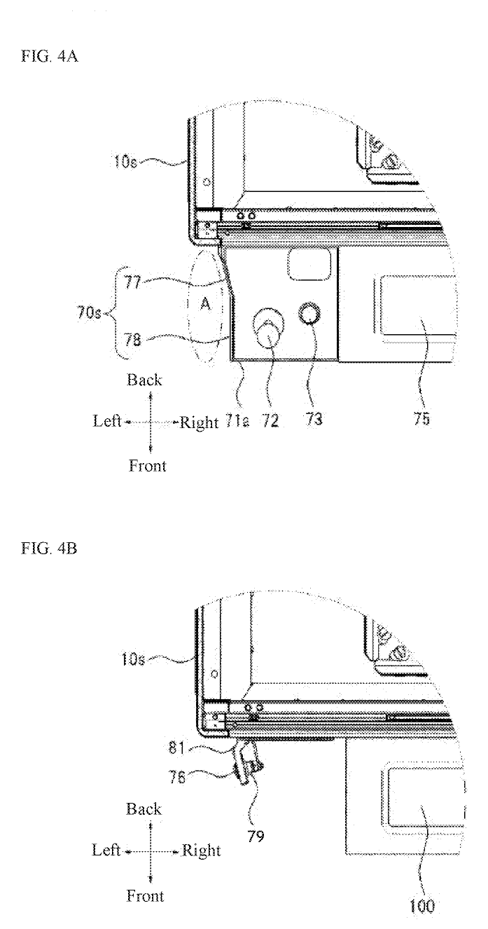

A configuration example of the operation console 70 according to one or more embodiments will be described with reference to FIG. 1, FIGS. 3A-3B, and FIGS. 4A-4B. FIG. 3A is a perspective view illustrating the left end of the operation console 70 before a first operation unit 71a on the left side is removed. FIG. 3B is a perspective view illustrating the left end of the operation console 70 after the first operation unit 71a on the left side is removed. FIG. 4A is a plan view illustrating the left end of the operation console 70 before the first operation unit 71a on the left side is removed. FIG. 4B is a plan view illustrating the left end of the operation console 70 after the first operation unit 71a on the left side is removed.

The operation console 70 is used when the player performs a game operation or when a store staff operates the settings. As illustrated in FIG. 1, the operation console 70 in one or more embodiments has an operation unit 71, a coin slot 74, a setting unit 75, and the keyhole 76.

The operation unit 71 is disposed on both a left and right end of the operation console 70, and has a joystick 72 and an operation button 73.

As illustrated in FIG. 1, the operation unit 71 in one or more embodiments has the first operation unit 71a on the left end and a second operation unit 71b on a right end, which are disposed to correspond to the first play area on the left side and the second play area on the right side, respectively.

As illustrated in FIG. 4A, the left side surface of the first operation unit 71a in one or more embodiments is constituted by a first side surface formed inclined toward the front side in the front-back direction, and a second side surface formed so as to be parallel to a side surface 10s of the casing 10. In addition, the right side surface of the second operation unit 71b is also constituted in a similar manner.

With this configuration, even when the prize acquisition game device 1 is installed at a corner of a store passageway, it is unlikely to be an obstacle for a passerby. In addition, even when the prize acquisition game device 1 is installed close to a wall, for example, the prize retrieval outlet 61 (see FIG. 1) for retrieving a prize may be easily seen.

The joystick 72 is an operation lever used by the player to move the prize acquisition unit 20 in the horizontal direction. The operation button 73 is an operation button used by the player to determine the position of the prize acquisition unit 20 in the horizontal direction. When the operation button 73 is pushed by the player, the prize acquisition unit 20 starts to lower at the determined position.

The coin slot 74 is disposed on an upper center surface of the operation console 70 and is used by the player to pay the playing fee.

The prize acquisition game is started when the player inserts a predetermined number of coins into the coin slot 74. The coin slot 74 in one or more embodiments is disposed to correspond to the first play area on the left side and the second play area on the right side, respectively.

The setting unit 75 is disposed on the upper center surface of the operation console 70 and is for use by store staff when performing operations related to the settings of the prize acquisition game. The setting unit 75 has a setting operation unit and a display unit (or display). The setting unit 75 in one or more embodiments is disposed to correspond to the first play area on the left side and the second play area on the right side, respectively.

The setting operation unit is for receiving an operation input related to game settings. The setting operation unit in one or more embodiments is constituted by a touch panel, and receives an input instruction from an operator from a pressed position thereof.

The touch panel is layered on top of the display unit, and when a touch operation is performed on the screen, the pressed position (contact position) may be detected based on a change in electrostatic capacitance between a fingertip and a conductive film.

The display unit is for displaying a setting screen of the prize acquisition game. The display unit 102 in one or more embodiments is constituted by a liquid crystal display. Note that the display unit may also display a game screen related to the prize acquisition game, or a guide screen encouraging the player to play the game.

As illustrated in FIG. 3A, the keyhole 76 is disposed on a side surface 70s of the operation console 70, and a key for operating the locking mechanism 80 that brings the opening/closing door 11 into a locked state or an unlocked state may be inserted thereinto. The keyhole 76 in one or more embodiments is disposed to correspond to the left door 11a and the right door 11b, respectively.

In one or more embodiments, as illustrated in FIGS. 3A and 4A, a mounting surface 77 of the keyhole 76 is disposed on the side surface 70s of the operation console 70, in a state of being oriented obliquely forward. That is, as illustrated in FIGS. 4A and 4B, the keyhole 76 is disposed such that the direction in which the key is taken out from the keyhole 76 coincides with the normal direction of the mounting surface 77, both oriented obliquely forward, and the normal direction of the mounting surface 77 intersects the front-back direction obliquely.

By disposing in this manner, even when the keyhole 76 is disposed on the side surface 70s of the operation console 70, visibility is improved compared to when the normal direction of the mounting surface 77 (that is, the direction in which the key is taken out from the keyhole 76) and the front-back direction intersect at right angles, this makes it easier to insert the key into the keyhole and take out the key from the keyhole. In addition, even when viewed from the front, the prize acquisition game device 1 may have more enhanced design appearance than when the keyhole is disposed on an upper surface of the operation console 70 or on the front surface of the casing 10.

Furthermore, in one or more embodiments, as illustrated in FIGS. 3A and 4A, in addition to the mounting surface 77 (first side surface) of the keyhole 76, a plane 78 (second side surface) parallel to the side surface 10s of the casing 10 is formed on the side surface 70s of the operation console 70 so as to be continuous with the mounting surface 77. As a result, the keyhole position is not unnecessarily noticeable when viewed from the front, which further enhances the design appearance.

In addition, in one or more embodiments, as illustrated in FIG. 1, the length of the operation console 70 in the left-right direction is configured to be made shorter than the length of the casing 10 in the left-right direction. With such a configuration, as illustrated in FIG. 4A, a key operation space A for performing key operations on the keyhole 76 may be formed on both the left and right sides of the operation console 70.

As a result, for example, even when the prize acquisition game device 1 is installed having the side surface 10s of the casing 10 close to a wall or the prize acquisition game device 1 is installed next to another game device, the key operation space A is ensured on both the left and right sides of the operation console 70 as illustrated in FIG. 4A, making it easier to insert the key into and take out the key from the keyhole 76.

### Locking mechanism 80

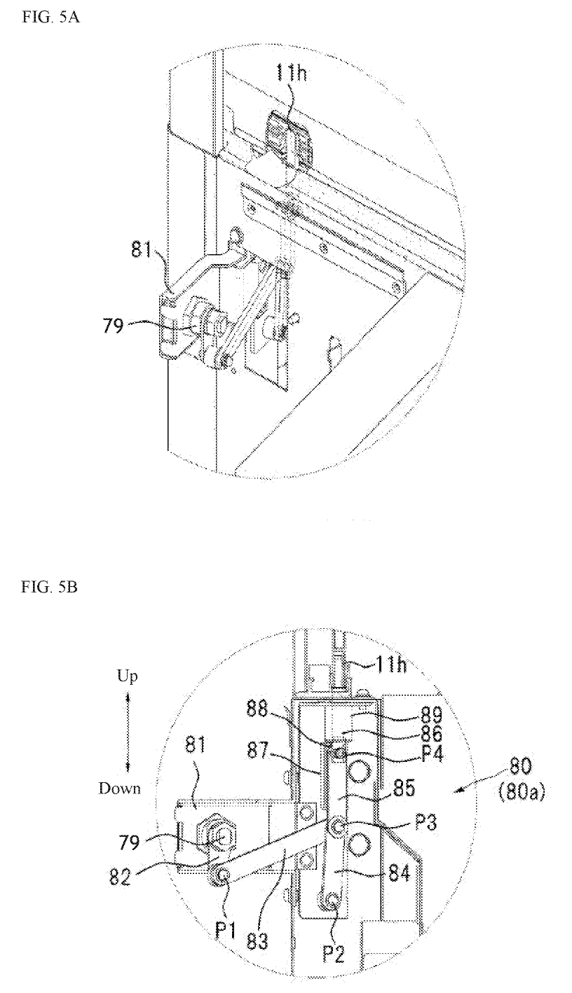

A configuration example of the locking mechanism 80 according to one or more embodiments will be described with reference to FIGS. 3A to 5B. FIG. 5A is a schematic perspective view illustrating the first locking mechanism 80a when the left door 11a is brought into a locked state. FIG. 5B is a schematic cross-sectional view illustrating the first locking mechanism 80a when the left door 11a is brought into a locked state. Note that in FIGS. 5A-5B, a state in which the first operation unit 71a on the left side is removed is illustrated.

The locking mechanism 80 is disposed on the inner side of the base unit 60, and is for bringing the opening/closing door 11 into a locked state or an unlocked state by rotation of the key inserted into the keyhole 76 disposed on the side surface of the operation console 70.

The locking mechanism 80 in one or more embodiments has a first locking mechanism 80a for the left door which is operated by rotation of the key inserted into the keyhole 76, present on the left side surface of the operation console 70, and a second locking mechanism 80b for the right door which is operated by rotation of the key inserted into the keyhole 76, present on the right side surface of the operation console 70, and these are disposed to correspond to the left door 11a and the right door 11b, respectively.

The first locking mechanism 80a for the left door and the second locking mechanism 80b for the right door have the same mechanism, and will therefore be specifically described hereinafter using the first locking mechanism 80a for the left door.

### Configuration of locking mechanism 80

As illustrated in FIGS. 5A-5B, the first locking mechanism 80a in one or more embodiments uses a link mechanism having a plurality of link bars to bring the left door 11a into a locked state or an unlocked state.

As illustrated in FIGS. 3B and 4B, the keyhole 76 on the left side surface of the operation console 70 is disposed in a cylinder 79 that stretches in the insertion direction of the key. The cylinder 79 is mounted to a base member 81 so that the keyhole 76 is oriented obliquely forward.

As illustrated in FIGS. 3B and 5B, a cylinder cam 82 is mounted to the inner side of the cylinder 79 with the base member 81 sandwiched therebetween.

The cylinder cam 82 is rotatably connected to one end of a first link bar 83 via a first pin P1. The position of the first pin P1 may be changed in accordance with the rotation of the cylinder cam 82.

The other end of the first link bar 83 is rotatably connected to one end of each of a second link bar 84 and a third link bar 85 via a third pin P3. The position of the third pin P3 may be changed in accordance with a movement of the first link bar 83.

The other end of the second link bar 84 is rotatably connected to the inner side of the base unit 60 via a second pin P2. The second pin P2 is fixed in position.

The other end of the third link bar 85 is rotatably connected to a lower end of a lock pin 86 via a fourth pin P4. A roller 88 is attached to a rear side of the fourth pin P4, with the lock pin 86 sandwiched therebetween. The roller 88 is engaged with a guide rail 87 having a U-shaped cross section. Note that the cross section of the guide rail 87 may be an L-shape.

The lock pin 86 is guided by a pin guide 89 in accordance with the movement of the roller 88, and the upper end thereof is fitted into a lock hole 11h disposed at the lower end of the left door 11a, thereby bringing the left door 11a into a locked state.

### Operation of locking mechanism 80

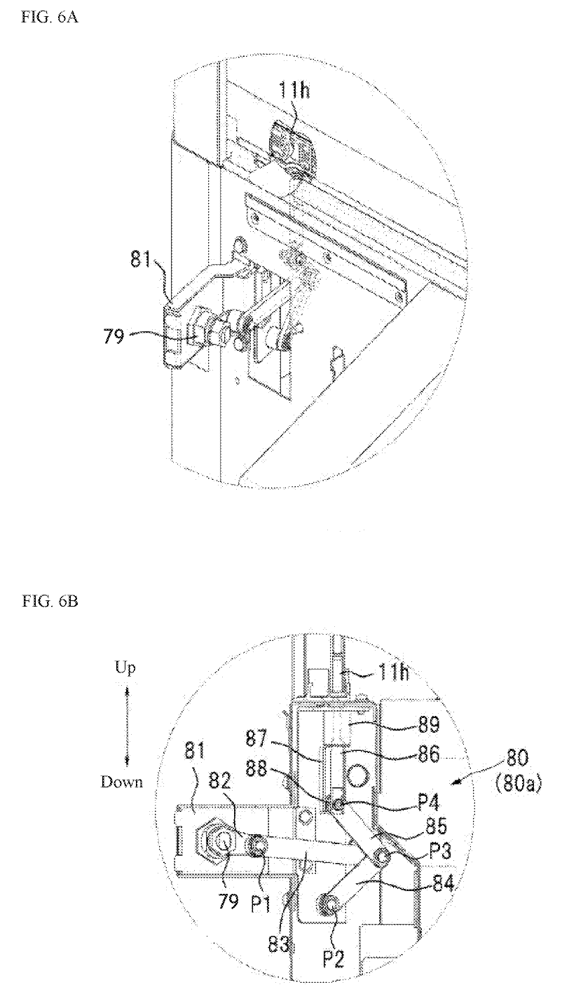

The operation of the locking mechanism 80 according to one or more embodiments will be described with reference to FIGS. 5A-5B and FIGS. 6A-6B. FIG. 6A is a schematic view illustrating the first locking mechanism 80a when the left door 11a is brought into an unlocked state. FIG. 6B is a schematic cross-sectional view illustrating the first locking mechanism 80a when the left door 11a is brought into an unlocked state.

When the left door 11a is in a locked state (is locked) (see FIG. 5B), the key is inserted into the keyhole 76 and the cylinder 79 is rotated clockwise. The cylinder cam 82 mounted to the cylinder 79 also rotates clockwise at the same time.

When the cylinder cam 82 is rotated clockwise, the first pin P1 also rotates clockwise in conjunction with the rotation of the cylinder cam 82, and the first link bar 83, which is pushed by the first pin P1, moves to the back side (see FIG. 6B).

When the first link bar 83 moves to the back side, the third pin P3 moves ti the back side in conjunction with the movement of the first link bar 83, and the second link bar 84, which is pushed by the third pin P3, rotates clockwise with the second pin P2 as an axis. At the same time, the third link bar 85, which is pushed by the third pin P3, moves the roller 88 of the fourth pin P4 downward along the guide rail 87 in the up-down direction.

When the roller 88 of the fourth pin P4 moves downward along the guide rail 87 in the up-down direction, the lock pin 86 moves downward along the pin guide 89 in the up-down direction in conjunction with the movement of the roller 88. As a result, the tip of the lock pin 86 comes out of the lock hole 11h of the left door 11a, and the left door 11a is brought into an unlocked state (is unlocked).

This allows the store staff to slide the left door 11a to the right side, which further allows the store staff to perform operations such as displaying and replenishing of prizes, or the like, in the first play area on the left side.

When the closed left door 11a is brought into an unlocked state (is unlocked) (see FIG. 6B) after the display, replenishment, or the like of the prizes is completed, the key is inserted into the keyhole 76 and the cylinder 79 is rotated counterclockwise. The cylinder cam 82 mounted to the cylinder 79 also rotates counterclockwise at the same time.

When the cylinder cam 82 is rotated counterclockwise, the first pin P1 rotates counterclockwise in conjunction with the rotation of the cylinder cam 82, and the first link bar 83, which is pulled back by the first pin P1, moves to the front side (see FIG. 5B).

When the first link bar 83 moves to the back side, the third pin P3 also moves to the front side in conjunction with the movement of the first link bar 83, and the second link bar 84, which is pulled back by the third pin P3, rotates counterclockwise with the second pin P2 as an axis. At the same time, the third link bar 85, which is pulled back by the third pin P3, moves the roller 88 of the fourth pin P4 upward along the guide rail 87 in the up-down direction.

When the roller 88 of the fourth pin P4 moves upward along the guide rail 87 in the up-down direction, the lock pin 86 moves upward along the pin guide 89 in the up-down direction in conjunction with the movement of the roller 88. As a result, the tip of the lock pin 86 is fitted into the lock hole 11h of the left door 11a, and the left door 11a is brought into a locked state (is locked).

### Other embodiments

The above embodiments are provided to facilitate understanding of the present invention, and are not to be construed as limiting the present invention. The present invention may be modified or improved without departing from the spirit thereof, and the present invention also includes equivalents thereof. In particular, the embodiments described below are also included in the present invention. In other words, the present invention may be configured by appropriately combining the above embodiments with the embodiments described below.

### Locking mechanism

In the embodiments described above, the locking mechanism 80 using the linking mechanism was described as an example; however, the present invention is not limited thereto. For example, the lock pin 86 may be configured to be fitted directly or indirectly into the lock hole 11h of the opening/closing door 11 by using a detection unit/detector (a switch, a sensor, or the like) or a drive unit/driver (a solenoid, a motor, or the like).

### Prizes

In the embodiments described above, the prizes housed in the casing 10 are not limited to items that the player is able to directly obtain (for example, stuffed toys or the like), but also include items that are housed as targets for acquisition in the game and may be exchanged for other prizes after acquisition, or items that are not provided themselves but are used to compete for points or rankings.

### DESCRIPTION OF REFERENCE NUMERALS

1 prize acquisition game device,

10 casing,

10s side surface,

11 opening/closing door,

11a left door,

11b right door,

11h lock hole,

12 pillar portion,

20 prize acquisition unit (prize catcher),

21 arm,

50 moving unit,

51 horizontal moving unit,

52 vertical moving unit,

52a lifting member,

53 left-right moving unit,

53a fixed rail,

53b left-right movement motor,

54 front-back moving unit,

54a movable rail,

54b front-back movement motor,

60 base unit

61 prize retrieval outlet,

70 operation console,

70s side surface,

71 operation unit,

71a first operation unit,

71b second operation unit,

72 joystick,

73 operation button,

74 coin slot,

75 setting unit

76 keyhole,

77 mounting surface,

78 flat surface,

79 cylinder

80 locking mechanism,

80a first locking mechanism,

80b second locking mechanism,

81 base member,

82 cylinder cam,

83 first link bar,

84 second link bar,

85 third link bar,

86 lock pin,

87 guide rail,

88 roller,

89 pin guide,

A key operation space,

P1 first pin,

P2 second pin,

P3 third pin,

P4 fourth pin

What is claimed is:

1. A prize acquisition game device comprising:
a casing that houses a prize;
an opening/closing door disposed on a front surface of the casing;
an operation console disposed protruding forward of the casing;
a prize catcher that comprises an arm and acquires the prize based on a game operation performed on the operation console; and
a locking mechanism that locks or unlocks the opening/closing door with rotation of a key inserted into a keyhole, wherein
a mounting surface of the keyhole is disposed on a side surface of the operation console to be oriented obliquely forward.

2. The prize acquisition game device according to claim 1, wherein:
the opening/closing door includes a left door and a right door,
the locking mechanism includes a first locking mechanism for the left door and a second locking mechanism for the right door, and
the mounting surface includes:
a left mounting surface disposed on a left side surface of the operation console to be oriented obliquely forward, and
a right mounting surface disposed on a right side surface of the operation console to be oriented obliquely forward.

3. The prize acquisition game device according to claim 2, wherein
the operation console has a length in a left-right direction shorter than a length of the casing in a left-right direction to form a key operation space on both a left and right side of the operation console.
